(19) United States
(12) Patent Application Publication
(10) Pub. No.: US 2014/0035796 A1
(43) Pub. Date: Feb. 6, 2014

(54) EPOSTERBOARDS

(71) Applicant: ePosterboards, LLC, Sudbury, MA (US)

(72) Inventor: Mark Phillippe, South Burlington, VT (US)

(73) Assignee: ePosterboards, LLC, Sudbury, MA (US)

(21) Appl. No.: 13/952,265

(22) Filed: Jul. 26, 2013

Related U.S. Application Data
(60) Provisional application No. 61/678,235, filed on Aug. 1, 2012.

(51) Int. Cl. G09G 3/20

(52) U.S. Cl. CPC G09G 3/20
USPC 345/2.2

(57) ABSTRACT

The present application provides, inter alia, solutions to advance poster presentations, e.g., to provide a service to meeting venues and sponsoring organizations by providing the video display hardware and connectivity needed for poster presenters to display their work in a dynamic, interactive state-of-the-art fashion.

### CROSS-REFERENCES TO RELATED APPLICATIONS

This application claims the benefit of U.S. Provisional Application No. 61/678,235, filed Aug. 1, 2012, incorporated herein by reference in its entirety and for all purposes.

### BACKGROUND OF THE INVENTION

Thousands of poster presentations occur annually at meetings, seminars, workshops, symposia, conferences and conventions sponsored by a variety of sponsoring groups including biomedical, technologic, scientific and other groups, societies and organizations. These meetings, seminars, workshops, symposia, conferences and conventions are held in meeting venues including hotel conference rooms, convention centers, and the like.

The format for the poster presentations by the attendees at these meetings have changed little with the advancement of technology. For example, poster presentations continue to be displayed by pinning a printed paper poster to a large (e.g., 6×4 foot) poster-board. Although there have been some improvements in the paper poster display (e.g., utilization of high quality, large format printers), poster presentations remain static, two dimensional representations of the presenters work or research. Moreover, in addition to the inconvenience of transporting posters to and from meeting venues (e.g., because of the large size of a typical poster even when rolled and placed in travel tubes), posters are at risk for damage during transport and hanging (e.g., ink can run when wet, and paper can tear or crease if mishandled). Additionally, once printed, the material on the poster is dated. For example, meeting attendees (e.g., presenters) are typically unable to make last minute corrections or provide updated information to their poster which may need to be printed days or even weeks before the meeting.

The advent of modern technology (i.e. large-format, flat panel displays, miniaturized computer technology), poster development software (e.g., Microsoft® PowerPoint, Apple® Keynote, OpenOffice Impress, and the like) and very small, high capacity storage devices (i.e. laptop computers, flash drives, cellular phones, electronic pad computers, and the like) provides an opportunity to advance poster presentations significantly. However, to date the necessary hardware to take advantage of these recent technological advances has not been made available at the regional and national venues where poster presentations occur. The present application provides, inter alia, solutions to advance poster presentations, e.g., to provide a service to meeting venues and sponsoring organizations by providing video display hardware and connectivity needed for poster presenters to display their work in a dynamic, interactive, and state-of-the-art fashion.

### BRIEF SUMMARY OF THE INVENTION

In a first aspect, there is provided a method for facilitating a plurality of electronic informational presentations to be displayed simultaneously. The method includes (i) causing a plurality of video displays to be delivered to a meeting area. The method further includes (ii) arranging the plurality of video displays in a viewing configuration within the meeting area. The method further includes (iii) connecting the plurality of video displays to one or more computers. The method further includes (iv) causing a different electronic informational presentation to be displayed on each of the plurality of video displays using the one or more computers, thereby achieving a plurality of simultaneously displayed different electronic informational presentations.

In another aspect, there is provided a method of doing business. The method includes (i) receiving payment to facilitate a plurality of electronic informational presentations to be displayed simultaneously in a meeting area. The method further includes (ii) causing a plurality of video displays to be delivered to the meeting area. The method further includes (iii) arranging the plurality of video displays in a viewing configuration within the meeting area. The method further includes (iv) connecting the plurality of video displays to one or more computers. The method further includes (v) causing a different electronic informational presentation to be displayed on each of the plurality of video displays using the one or more computers, thereby achieving a plurality of simultaneously displayed different electronic informational presentations.

### BRIEF DESCRIPTION OF THE DRAWINGS

FIG. 1. FIG. 1 depicts a schematic representation of an exemplary video display and associated material. Legend: 101: video display; 102: monitor stand; 103: (optional) monitor base; 104: (optional) equipment shelf; 105: computer; 106: computer connection; 107: network.

FIG. 2. FIG. 2 depicts top views of exemplary viewing configurations as disclosed herein. FIG. 2A: around the periphery of a room; FIG. 2B: center cluster; FIG. 2C: plurality of cluster groups; FIG. 2D: numbered row. Legend: dark rectangle: video display.

FIG. 3. FIG. 3 depicts a block diagram of an exemplary computer system 300, as disclosed herein.

### DETAILED DESCRIPTION OF THE INVENTION

In a first aspect, there is provided a method for facilitating a plurality of electronic informational presentations to be displayed simultaneously. The method includes (i) causing a plurality of video displays to be delivered to a meeting area. The method further includes (ii) arranging the plurality of video displays in a viewing configuration within the meeting area. The method further includes (iii) connecting the plurality of video displays to one or more computers. The method further includes (iv) causing a different electronic informational presentation to be displayed on each of the plurality of video displays using the one or more computers, thereby achieving a plurality of simultaneously displayed different electronic informational presentations.

The terms “facilitating” and the like are used herein according to their plain and ordinary meaning and may include causing material and services to be provided (e.g., to a meeting area), including hardware (e.g., video displays, local network connections, remote network connections, one or more computers, hardware monitoring devices, and the like), software (e.g., software installed on one or more computers), and technical expertise. The term “providing material” is used herein according to its plain and ordinary meaning and may include transporting, unpacking, installing, testing and running the component systems (e.g., hardware and software) necessary to present an electronic informational presentation as disclosed herein. The term “providing services” is used herein according to its plain and ordinary meaning and may include providing the requisite technical expertise necessary to simultaneously display different electronic informational presentations at a venue.

The terms “presentation” and the like are used herein according to their plain and ordinary meaning and may include a showing (e.g., audio showing and/or visual showing or display) and/or explanation (e.g., scripted, memorized, extemporaneous or impromptu elaboration, question-and-answer session, and the like) of a topic conducted by one or more individuals (i.e., “presenters”) for the educational benefit of one or more individuals attending the presentation (i.e., “attendees,” “audience” or the like). Exemplary presentations include scientific presentations, sales presentations, motivational presentations, interviews, briefings, status reports, training, and the like, as known in the art. As used herein, the terms “informational presentation” and the like refer, in the customary sense, to a presentation conducted at a scientific, technological, biomedical or other informational meeting (e.g., sales meeting, sales presentation and the like), seminar, workshop, symposium, conference, or the like, and having the purpose of disseminating information to an audience. The terms “traditional poster presentation,” “poster presentation” are used herein according to their plain and ordinary meaning and may include a presentation that visually displays one or more of the sections of the presentation (e.g., background information, hypotheses, data, analyses, references and other information germane to the topic of a poster presentation), wherein the visual showings are literally provided on printed posters during the poster presentation.

Accordingly, the terms “electronic informational presentation,” “electronic poster presentation” and the like are used herein according to their plain and ordinary meaning and may refer to a poster presentation wherein visual displays are provided at least in part on a video display as described herein. The terms “video display,” “video display monitor,” electronic display device” and the like are used herein according to their plain and ordinary meaning and may include electronic displays (e.g., CRT display, flat panels, touch screens, smart boards and/or related technology including large video displays). The terms “large video display” and the like refer to video displays having a diagonal maximum measurement of about 16, 20, 24, 28, 32, 36, 40, 45, 50, 55, 60, 70, 80, 90 inches, or even greater. Absent express indication otherwise, the term “about” in the context of a numeric value refers to the nominal value ±10%. In one embodiment, the video display provides an aspect ratio, as known in the art, of 1:1, 4:3, 3:2, 5:3, 16:9, 1.85:1, 2.39:1, 3:1, or 4:1. In one embodiment, the video display provides an aspect ratio, as known in the art, of about 1:1, 4:3, 3:2, 5:3, 16:9, 1.85:1, 2.39:1, 3:1, or 4:1. In one embodiment, the video display provides a “landscape” orientation, as known in the art, having a wider horizontal dimension. In one embodiment, the video display provides a “portrait” orientation, as known in the art, having a taller vertical dimension.

Beneficially, electronic informational presentation can provide presenters and the audience high quality visual presentations include animations, video clips and multidimensional components, which high quality visual presentations are not available in traditional poster presentations.

In one embodiment, showings on a video display further augment showings provided on a printed poster. In one embodiment, all of the visual showings are provided on a video display.

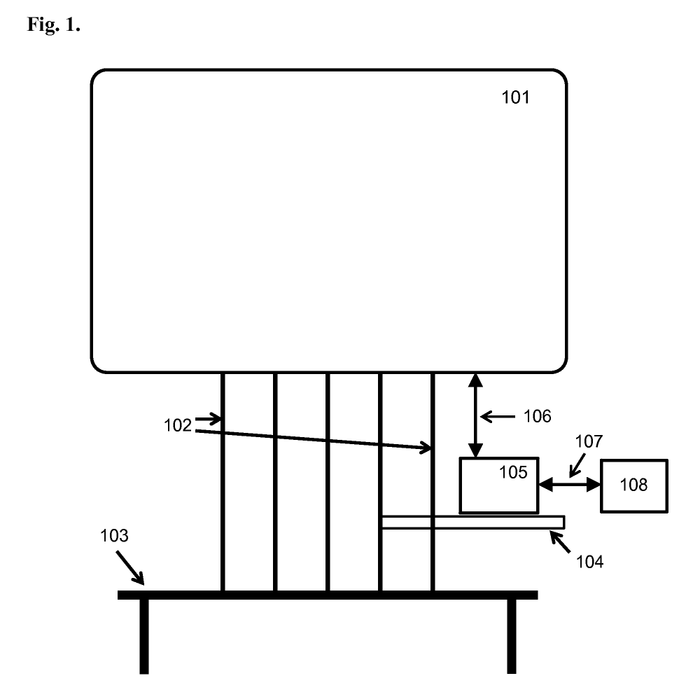

FIG. 1 depicts an exemplary video display 101 and associated material. In the figure, video display 101 is supported by optional monitor stand 102 which in turn is attached to optional monitor base 103. It is understood that monitor stand 102 and monitor base 103 are optional. For example, in one embodiment video display 101 is attached directly to a wall, or free standing element (e.g., portable screen, partition or the like), thereby obviating the necessity for monitor stand 102 and/or monitor base 103 to support video display 101. Conveniently, an optional equipment shelf 104 can be provided in proximity to video display 101. Equipment shelf 104 can support a computer 105 to drive the display of video display 101 via computer connection 106, network connection 107, informational brochures, and the like. Computer 105 can be connected via network connection 107 to a network 108 to provide control and data signals, monitoring signals, and the like. In one embodiment, equipment shelf 104 is not present. In one embodiment, computer 105, computer connection 106 and network connection 107 are not in plain view of the audience, e.g., suspended from the ceiling, concealed in the supporting wall, screen or partition to which video display 101 is attached, and the like.

The terms “displayed simultaneously” and the like are used herein according to their plain and ordinary meaning and may include simultaneous display or substantially simultaneous display of a plurality of electronic poster presentations. The term “substantially simultaneous display” in this context means that the display effectively functions in real time, neglecting noticeable or significant delays associated with electronic distribution (e.g., network delays and the like) in providing visual information to be displayed on a video display.

The method includes causing a plurality of video displays to be delivered to a meeting area. Exemplary meeting areas include business conference rooms, hotel conference rooms, schools and universities, convention centers, and the like. Methods for delivery of video displays are well known in the art.

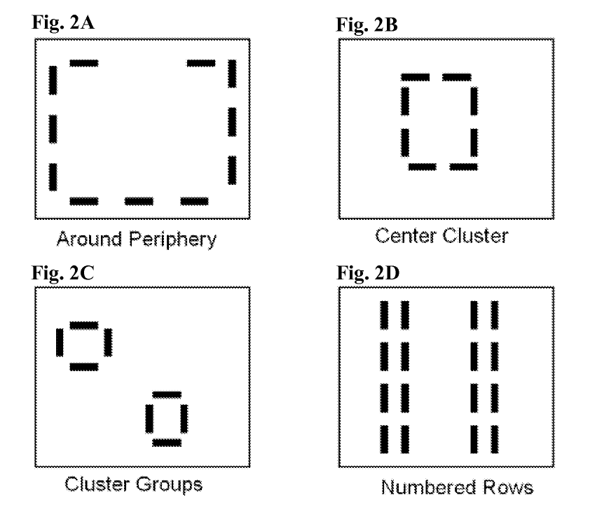

The method further includes arranging the plurality of video displays in a viewing configuration. The term “viewing configuration” refers, in the customary sense, to the spatial arrangement of video displays within a venue (e.g., a meeting room). Considerations for the arranging of video displays for a particular meeting depend on the size of the venue, the expected number of audience participants, the number of presenters, the presence of additional material to be distributed (e.g., brochures, handouts, preprints and the like), and other factors well known in the art. As depicted in FIG. 2, exemplary viewing configurations include arranging of video displays around the periphery of the room (FIG. 2A), as a center cluster (FIG. 2B), as a plurality of cluster groups (FIG. 2C), and numbered rows (FIG. 2D). Other viewing configurations are well known in the art.

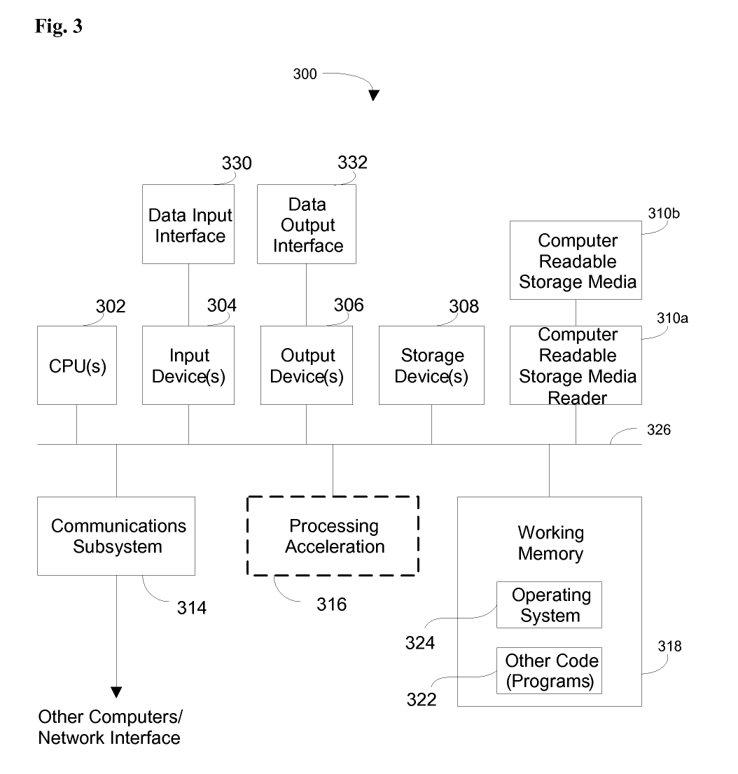

The method further includes connecting each of the plurality of video displays to one or more computers, e.g., computer 105 of FIG. 1. FIG. 3 is a block diagram of an exemplary computer system 300. It should be noted that FIG. 3 is meant only to provide a generalized illustration of various components, any or all of which may be utilized as appropriate. FIG. 3, therefore, broadly illustrates how individual system elements may be implemented in a relatively separated or relatively more integrated manner.

The computer system 300 is shown comprising hardware elements that can be electrically coupled via a bus 326 (or may otherwise be in communication, as appropriate). The hardware elements can include one or more central processor units (CPUs) 302, including without limitation one or more general-purpose processors and/or one or more special-purpose processors or processor cores. The hardware elements can further include one or more input devices 304, such as a computer mouse, a keyboard, a touchpad, and/or the like for providing user input to the CPU 302; and one or more output devices 306, such as a flat panel display device, a printer, visual projection unit, and/or the like.

The computer system 300 may further include (and/or be in communication with) one or more storage devices 308, which can comprise, without limitation, local and/or network accessible storage and/or can include, without limitation, a disk drive, a drive array, an optical storage device, solid-state storage device such as a random access memory (“RAM”), and/or a read-only memory (“ROM”), which can be programmable, flash-updateable, and/or the like.

The computer system 300 can also include a communications subsystem 314, which can include without limitation a modem, a network card (wireless or wired), an infra-red communication device, a wireless communication device and/or chipset (such as a Bluetooth device, an 802.11 device, a WiFi device, a WiMax device, cellular communication facilities, etc.), and/or the like. The communications subsystem 314 may permit data to be exchanged with other computers, with a network via a network interface, and/or any other external devices described herein. In many embodiments, the computer system 300 will further include a working memory 318, which can include RAM and/or ROM devices, as described above.

The computer system 300 also may include software elements, shown as being located within the working memory 318. The software elements can include an operating system 324 and/or other code, such as one or more application programs 322, which may comprise computer programs that are supported by the operating system for execution, and/or may be designed to implement methods described herein and/or configure systems as described herein. Merely by way of example, one or more procedures described with respect to the method(s) discussed above might be implemented as code and/or instructions executable by a computer (and/or a processor within a computer) such as the computer system 300. A set of these instructions and/or code might be stored on a computer readable storage medium 310b. In some embodiments, the computer readable storage medium 310b is the storage device(s) 308 described above. In other embodiments, the computer readable storage medium 310b might be incorporated within a computer system. In still other embodiments, the computer readable storage medium 310b might be separate from the computer system (i.e., it could be a removable medium, such as a compact disc, optical disc, flash memory, etc.), and or provided in an installation package, such that the storage medium can be used to program a general purpose computer with the instructions/code stored thereon. These instructions might take the form of executable code, which is executable by the computer system 300 and/or might take the form of source and/or installable code, which, upon compilation and/or installation on the computer system 300 (e.g., using any of a variety of generally available compilers, installation programs, compression/decompression utilities, etc.), then takes the form of executable code. In these embodiments, the computer readable storage medium 310b may be read by a computer readable storage media reader 310a of the computer system 300.

The various components of the computer system 300 communicate with each other via a system bus 326. Optional processing acceleration 316 may be included in the computer system, such as digital signal processing chips or cards, graphics acceleration chips or cards, and/or the like. Such processing acceleration may assist the CPU 302 in performing the functions described herein with respect to providing the display images.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In some embodiments, one or more of the input devices 304 may be coupled with a data input interface 330. For example, the data input interface 330 may be configured to directly interface with the output devices 306, whether physically, optically, electromagnetically, or the like. Further, in some embodiments, one or more of the output devices 306 may be coupled with data output interface 332. The data output interface 332 may be configured, for example, to produce data suitable for controlling tools or processes associated with the electronic presentation.

In one embodiment, some or all of the display functions described herein are performed by the computer system 300 in response to the CPU 302 executing one or more sequences of one or more instructions (which might be incorporated into the operating system 324 and/or other code, such as an application program 322) contained in the working memory 318. Such instructions may be read into the working memory 318 from another machine-readable medium, such as one or more of the storage device(s) 308 (or 310a). Merely by way of example, execution of the sequences of instructions contained in the working memory 318 might cause the processor(s) 302 to perform one or more procedures of the methods described herein.

The terms “machine readable medium” and “computer readable medium,” as used herein, refer to any medium that participates in providing data that causes a machine to operate in a specific fashion. In an embodiment implemented using the computational system 300, various machine-readable media might be involved in providing instructions/code to processor(s) 302 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) (308 or 310b). Volatile media includes, without limitation, dynamic memory, such as the working memory 318. Transmission media includes coaxial cables, copper wire, and fiber optics, including the wires that comprise the bus 326, as well as the various components of the communication subsystem 314 (and/or the media by which the communications subsystem 314 provides communication with other devices). Hence, transmission media can also take the form of waves (including, without limitation, radio, acoustic, and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the CPU 302 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computational system 300. These signals, which might be in the form of electromagnetic signals, acoustic signals, optical signals, and/or the like, are all examples of carrier waves on which instructions can be encoded, in accordance with various embodiments of the invention.

The communications subsystem 314 (and/or components thereof) generally will receive the signals, and the bus 326 then might carry the signals (and/or the data, instructions, etc. carried by the signals) to the working memory 318, from which the processor(s) 302 retrieves and executes the instructions. The instructions received by the working memory 318 may optionally be stored on a storage device 308 either before or after execution by the CPU 302.

In one embodiment, each video display is connected to a single computer. In one embodiment, a plurality of video displays are connected to a single computer. In one embodiment, one or more video displays are each connected to a single computer for each video display, and a plurality of video displays are connected to a single computer.

The method further includes causing a different electronic informational presentation to be displayed on each of the plurality of video displays using the one or more computers, thereby achieving a plurality of simultaneously displayed different electronic informational presentations.

In one embodiment, the informational content of each electronic informational presentation is provided at the computer connected to the video display for each electronic informational presentation. The terms “provided at the computer” and the like in this context refer, in the customary sense, to instructions and/or data input to a computer, e.g., via a computer readable medium, which contains content for the electronic informational presentation. In one embodiment, the data are contained in a presentation file, as known in the art, made with appropriate software, e.g., Microsoft® PowerPoint, Apple® Keynote, OpenOffice Impress, and the like.

In one embodiment, the method further includes monitoring each of the plurality of simultaneously displayed different electronic informational presentations. The term “monitoring” in this context refers, in the customary sense, to observing the electronic informational presentation as provided on the video display. In one embodiment, monitoring is conducted by direct visual observation by event staff having technical expertise in the art of video displays of electronic informational presentations. The term “monitoring” further contemplates observing the electronic functioning of the computer, video display and related components of the computer system. In one embodiment, a power fluctuation affecting the computer system is detected and reported to event staff. The terms “service staff,” “event staff” and the like are used herein according to their plain and ordinary meaning and may include trained personnel having the requisite technical expertise to conduct one or more of the steps of the methods disclosed herein. In one embodiment, a program fault (e.g., computer error, network error, and like) is detected and reported to event staff. Methods for reporting the results of monitoring in this context are well known in the art, and include visual or audio alarms, the dispatch of email and text messages, and the like.

In one embodiment, the method further includes detecting a display problem with one of the plurality of simultaneously displayed different electronic informational presentations. The terms “display problem” and the like refer, in the customary sense, to a condition which affects the quality of images displayed on a video display. In one embodiment, a display problem is a loss of signal to the video display. In one embodiment, a display problem is a deteriorated signal at a video display, resulting in deteriorated quality of the images on the video display. In one embodiment, a display problem is an improper signal delivered to a video display.

In one embodiment, the method further includes addressing the display problem. Methods for addressing a display problem depend on the specific display problem. For example, loss of signal to a video display may be corrected by replacement of cabling which has been determined to be defective, or if suspected of being defective. Loss of signal may result from a faulty signal connection, e.g., a signal cable becoming unplugged, and correction of the loss of signal may entail connecting the signal cable correctly. Loss of signal may result from a problem within the computer which provides the signal to the video display, and correction may entail replacing the computer and even simply re-booting the computer, as known in the art, and optionally re-loading the presentation file.

In one embodiment, the plurality of video displays is a plurality of large video displays. In one embodiment, each of the plurality of large video displays has a diagonal maximum measurement of about 16, 20, 24, 28, 32, 36, 40, 45, 50, 55, 60, 70, 80, 90 inches, or even greater. In one embodiment, each of the plurality of large video displays provides an aspect ratio of 1:1, 4:3, 3:2, 5:3, 16:9, 1.85:1, 2.39:1, 3:1, 4:1, other aspect ratio. In one embodiment, each of the plurality of large video displays provides an aspect ratio of about 1:1, 4:3, 3:2, 5:3, 16:9, 1.85:1, 2.39:1, 3:1, or 4:1. In one embodiment, each of the plurality of large video displays provides a “landscape” orientation. In one embodiment, each of the plurality of large video displays provides a “portrait” orientation.

In one embodiment, the plurality of video displays is 10 or more video displays. In one embodiment, the plurality of video displays is 10, 11, 12, 13, 14, 15, 16, 17, 18, 19, 20, 21, 22, 23, 24, 25, or more video displays.

In one embodiment, the one or more computers is one computer. In one embodiment, the one or more computer is more than one computer. In one embodiment, the one or more computers is equal in number to the plurality of video displays, wherein each of the plurality of video displays is connected to a different computer of the one or more computers.

In another aspect, there is provided a method of doing business. The method includes (i) receiving payment to facilitate a plurality of electronic informational presentations to be displayed simultaneously in a meeting area. The method further includes (ii) causing a plurality of video displays to be delivered to the meeting area. The method further includes (iii) arranging the plurality of video displays in a viewing configuration within the meeting area. The method further includes (iv) connecting the plurality of video displays to one or more computers. The method further includes (v) causing a different electronic informational presentation to be displayed on each of the plurality of video displays using the one or more computers, thereby achieving a plurality of simultaneously displayed different electronic informational presentations.

The terms “receiving payment” and the like are used herein according to its plain and ordinary meaning and may include a crediting of funds from an entity in anticipation of work to be conducted on behalf of the entity, or in payment for work which has been conducted on behalf of the entity. In one embodiment, payment is received for the entire estimated cost for facilitating a plurality of electronic informational presentations to be displayed simultaneously in a meeting area. In one embodiment, payment is received for an estimated retainer cost for facilitating a plurality of electronic informational presentations to be displayed simultaneously in a meeting area, wherein there is an expectation of receiving further payment to cover the entire cost of facilitating a plurality of electronic informational presentations to be displayed simultaneously in a meeting area. The entity may be the organization charged with the task of overseeing a meeting, seminar, workshop, symposium, conference or convention. In one embodiment, the entity is an individual responsible for overseeing a meeting, seminar, workshop, symposium, conference or convention. Crediting of funds may take a form well known in the art, including e.g., cash payment, credit card payment, electronic fund transfer, and the like.

In one embodiment, receiving payment occurs prior to other steps of the method. In one embodiment, receiving payment occurs during the display of the plurality of electronic informational presentations displayed simultaneously in a meeting area. In one embodiment, receiving payment occurs after the meeting, seminar, workshop, symposium, conference or convention, wherein electronic informational presentations were displayed simultaneously in a meeting area.

In one embodiment, the plurality of video displays are delivered from a storage facility. The terms “storage facility” and the like refer, in the customary sense, to a space, e.g., warehouse, other building, rental storage locker, and the like, for securely holding equipment, e.g., video displays, computers, computer stands, cabling, computer and video display test equipment, and the like. Methods for delivering video displays from a storage facility are well known in the art, e.g., as disclosed herein.

In one embodiment, the method further includes monitoring each of the plurality of simultaneously displayed different electronic information presentations, as disclosed herein.

In one embodiment, the method further includes detecting a display problem with one of the plurality of simultaneously displayed different electronic informational presentations, using methods disclosed herein.

In one embodiment, the method further includes addressing a display problem detected with one of the plurality of simultaneously displayed different electronic informational presentations. Methods for addressing a display problem are known in the art, e.g., as disclosed herein.

In one embodiment of the method, the plurality of video displays is a plurality of large video displays, as disclosed herein.

In one embodiment of the method, plurality of video displays is 10 or more video displays, e.g., 10, 11, 12, 13, 14, 15, 16, 17, 18, 19, 20, 21, 22, 23, 24, 25, or even more.

In one embodiment of the method, the one or more computers is one computer. In one embodiment, the one or more computer is more than one computer. In one embodiment, the one or more computers is equal in number to the plurality of video displays, wherein each of the plurality of video displays is connected to a different computer of the one or more computers.

In summary, as described herein, conventional poster board presentations using static printed paper posters result in challenging concessions for both presenters and their sponsoring organizations. For example, in addition to the cost and effort involved in preparation and printing the paper posters, meeting attendees need to transport these large, often odd shaped materials (e.g., commonly in a 3 or 4 foot long tube cases or cardboard tubes) to and from the meeting venues, which effort can be both challenging and inconvenient especially during airplane travel. In addition, presenters need to pin their paper posters up before the beginning of the meeting poster session and take it down afterward, during which the paper poster could be damaged by ink smears, creasing or tearing.

Accordingly, there is provided a service useful to eliminate the above concessions and problematic issues. Specifically, meeting attendees can prepare their presentations on their own software (e.g., Microsoft® PowerPoint, Apple® Keynote, OpenOffice Impress, and the like) with the opportunity to modify, correct or update the presentation even up to the time of video display. The presentation software can be transported to and from the meeting by the presenters using miniature or hand-held devices (e.g., laptop computers, flash drives, cellular phones, electronic pad computers, and the like). Once at their meeting, the disclosed methods allow the presenters to display their presentations on large-format, flat screen monitors with minimal effort (i.e., essentially plug-and-play). Because of the multidimensional capabilities of the presentation software, the poster displays can be as interactive and animated as the presenter desires. In essence, the methods disclosed herein provide a whole new experience and dimension to meeting presentations.

Moreover, for sponsoring organizations arranging for the services disclosed herein, the service staff will transport all necessary equipment to the meeting venue and unpack it. In an exemplary sequence of events for conducting the methods disclosed herein, the service staff will set up large-format video display monitors along with the necessary connectivity (i.e. computers including USB ports, HDMI, DVI-D, S-video and other connections as known in the art, related cables and technology, and the like) to allow meeting attendees to display their poster materials contained on their personal media (e.g., laptop computers, flash drives, cellular phones, electronic pad computers, and the like). The service staff will set up the video displays on portable stands and place them in the meeting space according to the meeting organizer's requests (e.g., around the periphery of the room, in small clusters, in numbered rows, and the like). The service staff will be responsible for the setting up the power connections and assuring that the video displays (and related equipment) are fully operational. The service staff will assist meeting presenters in connecting their personal media (containing their presentation material) to the provided equipment to assure optimal display of the presenter's video poster. During the poster-presentation sessions scheduled by the sponsoring organization, the service staff will remain on-site to provide technical assistance as required. At the end of the meeting venue, the service staff will disconnect the equipment, box and remove it, e.g., to a storage facility.

What is claimed is:

1. A method for facilitating a plurality of electronic informational presentations to be displayed simultaneously, said method comprising:
(i) causing a plurality of video displays to be delivered to a meeting area;
(ii) arranging said plurality of video displays in a viewing configuration within said meeting area;
(iii) connecting said plurality of video displays to one or more computers; and
(iv) causing a different electronic informational presentation to be displayed on each of said plurality of video displays using said one or more computers thereby achieving a plurality of simultaneously displayed different electronic informational presentations.

2. The method of claim 1, further comprising monitoring each of the plurality of simultaneously displayed different electronic informational presentations.

3. The method of claim 1, further comprising detecting a display problem with one of said plurality of simultaneously displayed different electronic informational presentations.

4. The method of claim 3, further comprising addressing said display problem.

5. The method of claim 1, wherein said plurality of video displays is a plurality of large video displays.

6. The method of claim 1, wherein said plurality of video displays is 10 or more video displays.

7. The method of claim 1, wherein said one or more computers is one computer.

8. The method of claim 1, wherein said one or more computers is equal in number to said plurality of video displays, and wherein each of said plurality of video displays is connected to a different computer.

9. A method of doing business, said method comprising:
(i) receiving payment to facilitate a plurality of electronic informational presentations to be displayed simultaneously in a meeting area;
(ii) causing a plurality of video displays to be delivered to the meeting area;
(iii) arranging said plurality of video displays in a viewing configuration within said meeting area;
(iv) connecting said plurality of video displays to one or more computers; and
(v) causing a different electronic informational presentation to be displayed on each of said plurality of video displays using said one or more computers thereby achieving a plurality of simultaneously displayed different electronic informational presentations.

10. The method of claim 9, wherein said plurality of video displays are delivered from a storage facility.

11. The method of claim 9, further comprising monitoring each of the plurality of simultaneously displayed different electronic informational presentations.

12. The method of claim 9, further comprising detecting a display problem with one of said plurality of simultaneously displayed different electronic informational presentations.

13. The method of claim 12, further comprising addressing said display problem.

14. The method of claim 9, wherein said plurality of video displays is a plurality of large video displays.

15. The method of claim 9, wherein said plurality of video displays is 10 or more video displays.

16. The method of claim 9, wherein said one or more computers is one computer.

17. The method of claim 9, wherein said one or more computers is equal in number to said plurality of video displays, and wherein each of said plurality of video displays is connected to a different computer.
